(19) United States
(12) Patent Application Publication
(10) Pub. No.: US 2022/0300996 A1
(43) Pub. Date: Sep. 22, 2022

(54) COMPUTER-IMPLEMENTED METHODS FOR GENERATING CUSTOMER CREDIT FROM TARGETED MARKETING

(71) Applicants: Cosmin-Gabriel ENE, Zollikon (CH); Marcel ERNI, Zug (CH)

(72) Inventors: Cosmin-Gabriel ENE, Zollikon (CH); Marcel ERNI, Zug (CH)

(21) Appl. No.: 17/639,673

(22) PCT Filed: Sep. 3, 2020
(86) PCT No.: PCT/EP2020/074575

§ 371 Date: Mar. 2, 2022

Related U.S. Application Data
(60) Provisional application No. 62/895,155, filed on Sep. 3, 2019.

(51) Int. Cl. G06Q 30/02; G06Q 20/20

(52) U.S. Cl. CPC G06Q 30/0208; G06Q 30/0201; G06Q 30/0281; G06Q 20/204

(57) ABSTRACT

A computer-implemented method for generating customer credit for participation in a marketing activity at a merchant location, including the steps of: a) receiving device identification information for a mobile electronic device (UE) of a customer at a merchant server, indicating that the customer is present at or near the merchant location, b) transmitting information to UE inviting participation by the customer in a merchant location-based marketing activity, c) determining a customer completion of the marketing activity at the merchant location, d) issuing a request by the merchant server that a balance in an earnings account of the customer be updated to include a customer credit amount provided by the merchant for completion of the marketing activity, and e) determining whether the updated balance exceeds a predetermined threshold amount. When the threshold amount has been exceeded, an enrollment request is delivered to the mobile electronic device requesting the user to elect a payer from which to receive all or a portion of the credit balance.

### FIELD OF THE INVENTION

This disclosure pertains to computer-implemented methods for generating customer credit for participation in a marketing activity at a merchant location, and more particularly, pertains to computer-implemented methods for accumulating micro-payments for customers that participate in marketing activities at merchant locations as recognized upon completing such activities, and arranging to transfer payment to customers when accumulated micro-payments exceed a predetermined threshold.

### BACKGROUND

Merchants spend a significant amount of energy and costs on product and service marketing, both to stimulate purchase interest and to gather feedback for improving product and service offerings. These efforts often fall on deaf ears, as consumers perceive that marketing activities provide little direct benefit, or generate unwanted pressures to buy. In such cases, marketing activities are counter-productive. Annoyed consumers are turned off or away from purchasing associated products, and feedback gathered is either overly negative or superficial, and thus of little use.

Marketing activities have a much greater opportunity to stimulate product and service interest and useful feedback when participating consumers find some sort of perceived benefit or return on their investment. Perceived benefit may be highly correlated with consumers' personal interest in the products and services that are being marketed. For example, one might expect that a rock musician would have a stronger interest in participating in marketing activities surrounding guitar effects panels than garden hoses. Interest may also be correlated with the opportunity to receive a personalized reward for participation (for example, a money payment). Because an appropriate payment for participating in a several minute marketing activity might be on the order of a small fraction of a dollar (a micro-payment), it would be advantageous to accumulate earnings until a more substantial payment award can be made. For consumers who are just beginning to participate in these activities, it might be advantageous in addition to defer the burden of payment account activation for some time until a substantial payment is ready to be made.

### SUMMARY

By way of example, aspects of the present disclosure are directed to methods and systems for generating customer credit for participation in a marketing activity at a merchant physical location or store.

In accordance with aspects of the present disclosure, the disclosed computer-implemented method includes the steps of: a) receiving device identification information for a mobile electronic device (UE) of a customer at a merchant server, indicating that the customer is present at or in the vicinity of the merchant location, b) transmitting information to the mobile electronic device by the merchant server inviting participation by the customer in a merchant location-based marketing activity, c) determining a customer completion of the merchant location-based marketing activity by the merchant server at the merchant location, d) issuing a request by the merchant server that a balance in an earnings account of the customer be updated to include a customer credit amount provided by the merchant for completion of the marketing activity; and e) determining whether the updated balance in the earnings account exceeds a predetermined threshold amount. When the threshold amount has been exceeded, the merchant server may proceed to deliver an enrollment request to the mobile electronic device requesting the user to elect a payer from which to receive all or a portion of the credit balance.

In accordance with another aspect of the disclosure, the step of receiving device identification information at the merchant server includes the step of receiving a service request from the mobile electronic device of the customer at the merchant server, the service request made by the mobile electronic device enabled by a service code imaged by the mobile electronic device from signage displayed at the merchant location.

In accordance with further aspects of the disclosure, the step of receiving device identification information at the merchant server includes the step of receiving a detection broadcast signal from the mobile electronic device at the merchant server.

In accordance with further aspects of the disclosure, the step of receiving device identification information at the merchant server includes the step of receiving a proximity detection indication signal at the merchant server from a proximity server in communication with the merchant server and the mobile electronic device.

In accordance with other aspects of the disclosure, prior to inviting participation in the marketing activity, the merchant server may preferably query one of the mobile electronic device, an account server in communication with the merchant server or a network-accessible data store by the merchant server to obtain information indicating current interests of the customer; and then transmit the activity information to the mobile electronic device by the merchant server only upon determining that the current interests of the customer and the merchant location-based marketing activity are correlated.

In accordance with further aspects of the disclosure, one or more of the mobile electronic device, the merchant server or a network-accessible web server is configured as a marketing activity hosting node for one or more of monitoring user participation in the marketing activity or soliciting a user response to the marketing activity.

In accordance with further aspects of the disclosure, the completion indicator is generated by the marketing activity hosting node by determining that the mobile electronic device was in proximity to the merchant location for at least a predetermined time period.

In accordance with further aspects of the disclosure, the completion indicator is generated by the marketing activity hosting node upon receiving a user activity completion response from one of the mobile electronic device or a another terminal device at the merchant location. The completion response may, for example, include a completed user survey.

This SUMMARY is provided to briefly identify some aspects of the present disclosure that are further described below in the DESCRIPTION. This SUMMARY is not intended to identify key or essential features of the present disclosure nor is it intended to limit the scope of any claims.

### BRIEF DESCRIPTION OF THE DRAWING

A more complete understanding of the present disclosure may be realized by reference to the accompanying drawing in which:

FIG. 1 depicts an exemplary network infrastructure useable in accordance with aspects of the present disclosure;

FIG. 2 depicts a second exemplary network infrastructure useable in accordance with aspects of the present disclosure;

FIG. 3 depicts an exemplary message sequence diagram in accordance with the network infrastructure illustrated in FIG. 1;

FIG. 4A depicts an exemplary message sequence diagram in accordance in accordance with the network infrastructure illustrated in FIG. 2; and

FIG. 4B depicts another exemplary message sequence diagram in accordance in accordance with the network infrastructure illustrated in FIG. 2.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

Aspects of the present disclosure are directed to methods and systems for methods and systems for generating customer credit for participation in a marketing activity at a merchant physical location or store. Customers are identified as candidates for participation based on the sensing the presence, for example, of a customer mobile electronic device (also termed a “User Equipment Device,” or “UE device”), in proximity to a merchant store. Such devices may include, but are not limited to, personal digital assistants (PDAs), smartphones, tablet devices, and other devices capable of executing software application programs that may have been pre-installed on the device,

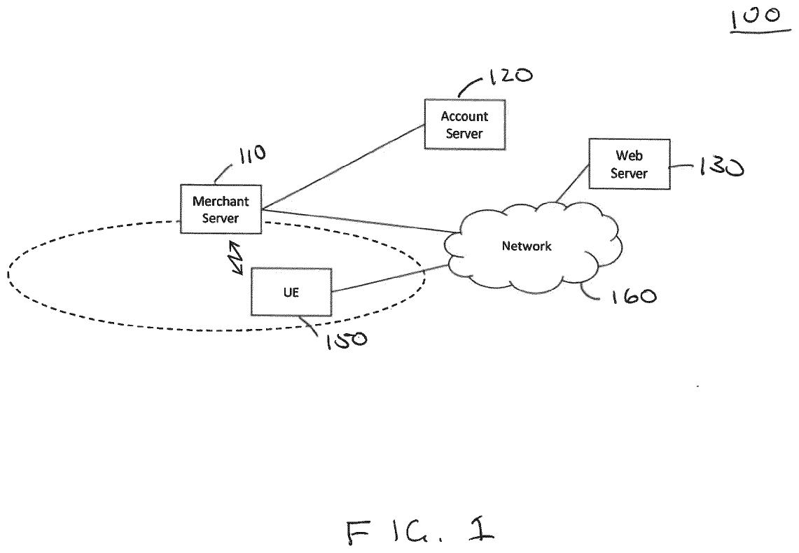

FIG. 1 shows a network or a sub-network consisting of a server computer operator by or for a merchant or performing network-based services for the merchant (Merchant Server 110). The Merchant Server 110 is connected to an Account Server 120 that has account information stored and that is enabled to look-up such account information for specific users associated with the respective accounts and provide the account information via the Network 160. Alternatively, for example, the Account Server 120 may be implemented as a component of the Merchant Server 110.

Also depicted is a mobile user device (UE 150) that has network connection means for at least connecting to the Merchant Server 110 wirelessly. The UE 150 and the Merchant Server 110 are shown in FIG. 1 in proximity, with a dashed ellipsis surrounding both entities. Proximity may mean that the distance between both nodes (UE 150 and Merchant Server 110) allows for direct communication via a short-range communication means like Wireless LAN (WLAN or Wi-Fi), Bluetooth, ZigBee or the like. Proximity may alternatively mean that both nodes are able to access the same WLAN network spanned by a WLAN access point. Proximity may also alternatively mean that the two nodes have a line-of-sight to each other, or that the geographical distance between both is lower or equal to a pre-defined maximum. All other examples of proximity having this same general sense are contemplated by this disclosure.

FIG. 1 further depicts a network infrastructure 100 that allows for an indirect connection at least between the UE 150 and the Merchant Server 110. By way of example, the UE 150 may have cellular mobile communication means based for example on various communication standards including GPRS, UMTS or LTE, and connect to a base station of a cellular mobile communication network. The Merchant Server 110 may for example be connected via an internet connection to the same cellular mobile communication network as the UE 150, so that the UE 150 and the Merchant Server 110 can communicate via the cellular mobile communication network. This communication path need not prevent the UE 150 and the Merchant Server 110 to communicate directly with each other, as previously described, in parallel to the connection via the cellular mobile network.

FIG. 1 further depicts a Web Server 130 connected via the Network 160 at least to the Merchant Server 110 and to the UE 150. The Web Server 130 may for example perform marketing activities with mobile devices like UE 150, which may include presenting web-pages to UEs 150 that request user-provided clear text information, selection of provided choices and, and to receive information from UEs 150, for example, with clear-text or selection information or the like. The Web Server 130 may also be enabled to communicate with the Merchant Server 110 via the Network 160, for example, for providing to the Merchant Server 110 information about the termination or completion of a marketing activity by a UE 150. The Web Server 120 may alternatively be implemented as a component of the Merchant Server 110 or the Account Server 120.

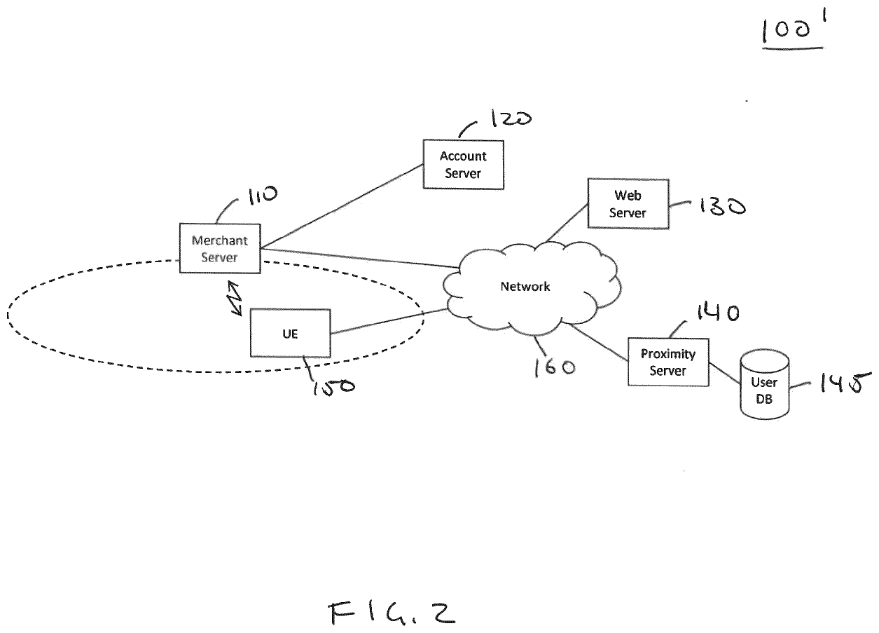

FIG. 2 depicts another embodiment of the present invention. In addition to nodes UE 150, Merchant Server 110, Web Server 130 and Account Server 120 as described with reference to FIG. 1, the Network Infrastructure 100′ of FIG. 2 includes a Proximity Server 140 with access to a user data base (User DB 145). The User DB 145 may for example be a part of the Proximity Server 140, or it may be implemented a separate node directly or indirectly connected to the Proximity Server 140. The Proximity Server 140 may alternatively be implemented as a component of the Merchant Server 110, the Web Server 130 or the Account Server 120.

The Proximity Server 140 has a main function to resolve temporary or pseudo-random identities of nodes into non-temporary, clear or global identities. Nodes like the Merchant Server 110 may announce their existence in their proximity towards other nodes, (e.g. the UE 150), and the Proximity Server 140 may authenticate the UE 150 to learn the merchant real name or unique ID, or authenticate the merchant to learn the identity of the UE 150 and/or and associated user. Also, the Proximity Server 140 may initiate a connection between two nodes which detected that they are in proximity of each other. The initiated connection may for example be a direct connection between the nodes using short-range communication means, or an indirect connection via the network infrastructure 100′ as illustrated in FIG. 2.

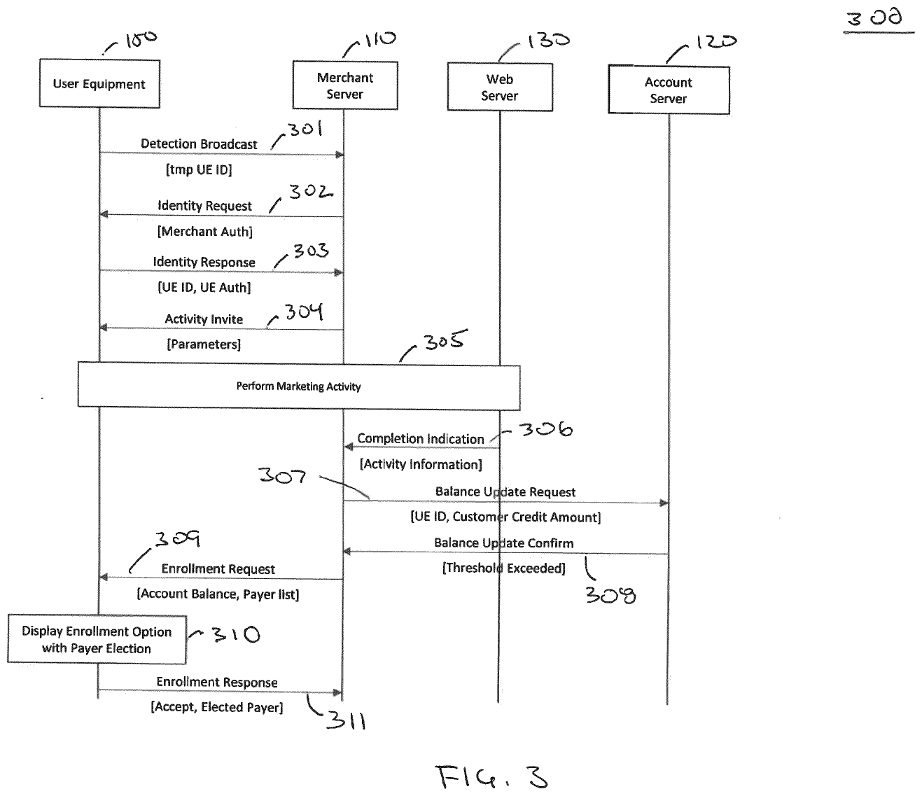

FIG. 3 depicts a Method 300 in accordance with aspects of this disclosure by means of a message sequence chart. The method can be carried out, for example, by the Network Infrastructure 100 illustrated in FIG. 1.

The Method 300 is based on circumstances under which the UE 150 is configured to announce its existence in proximity of the Merchant Server 110 (or alternatively a proximity detection means of the Merchant Server 110 not separately shown in FIG. 1). This may be done, for example, by the UE 150 by broadcasting a detection signal including a temporary or at least not-clear-text identity of the UE 150. The broadcasting may be performed by the UE 150 on a continuing basis, or based on the detection of certain events. The events may, for example, be pre-defined, configured or user-selected. They may for example be based on either or a combination of: a) the UE 150 entering an area defined by a geo-fence or a border, b) the UE 150 entering a cell or a group of cells of the cellular communication system, c) a point of time-of-day, or d) a date.

The Merchant Server 110 may be enabled to receive such broadcasted detection signals from a UE 150 in its proximity. With reference to step 301 of FIG. 3, when detecting the presence of a UE 150 in its proximity potentially comprising a temporary UE identity, the Merchant Server may transmit an Identity Request message to the UE 150 at step 302 requesting a non-temporary UE ID from the UE 150 that is indicative of an account of the UE 150 (i.e. an ID that the UE 150 used before to register an account and an ID the UE 150 has received in relation to creating an account). The Identity Request may for example comprise merchant authorization data to enable the UE 150 to decide whether the Identity Request message comes from a trustworthy node.

At step 303 of FIG. 3, the UE 150 may transmit to the Merchant Server 110 an Identity Response comprising at least the requested UE ID. In addition, the UE 150 may transmit in that message authentication data that can be used by the Merchant Server 110 to verify whether the correct UE ID is used by the UE 150.

The merchant may then invite the user of the UE 150, at step 304 via the Merchant Server 110, to participate in a marketing activity. The marketing activity may relate to the merchant and be conducted at a shop or another location of the merchant in proximity to the UE 150. Thus, the Merchant invites the customer to a location-based marketing activity. An Activity Invite message may for example be transmitted to the UE 150 by the Merchant Server 110 comprising information relating to the marketing activity at step 304.

Preferably, prior to the Merchant Server 110 transmitting the Activity Invite Message to the UE 150, the Merchant Server 110 may query one of UEs 150, an account server in communication with the Merchant Server or a network-accessible data store accessible to the Merchant Server 110 to obtain information indicating current interests of the customer. In this case, the Merchant Server 110 would then transmit the Activity Invite message only upon determining that the current interests of the customer and the merchant location-based marketing activity are correlated.

The information provided in the Activity Invite may comprise sufficient information so the UE 150 can offer to the customer the performance of the marketing activity autonomously. In one example, the information may comprise a form to be filled by the customer, e.g. with name, address, current interest of shopping and reason for being in or near the merchant's shop.

The information may alternatively comprise a link to a web site on which the customer can perform the marketing activity with the help of a browser app installed on the UE 150. This case is assumed, for example, for the Method 300 depicted in FIG. 1. The parameters contained in the Activity Invite message may for example have a URL included that, when opened by a browser application on the UE 150, open a respective web page hosted by the Web Server 130 with the location-based marketing activity requesting input from the customer or presenting further information to the customer.

The information in the Activity Invite may alternatively link the UE 150 to a marketing activity hosted on the Merchant Server 110, or alternatively on the UE 150, for example by an app performing such activities on request by the Merchant Server 110. Alternatively, the marketing activities may be carried out manually without the involvement of the UE 150 in the merchant's shop.

Block 305 of FIG. 3 illustrates the performance of the marketing activity as a block involving the UE 150, the Merchant Server 110 and the Web Server 130. Block 305 is intended to depict that various alternatives for performance of a marketing activity exists confirming with the sense of this invention, with potential participation by the UE 150, the Merchant Server 110 and the Web Server 130.

After the marketing activity is completed by the customer (for example, after the last question is answered, and/or a video is watched completely or requested information is fully provided), the marketing activity hosting node (in this example the Web Server 130) indicates the finalization to the Merchant Server 110 in a Completion Indication message at step 306 of FIG. 3. This message may comprise information relating to the completion of the activity (for example, a score that may be reached by the customer during the activity, a number of questions that may have been answered, or a participation time during which the activity lasted. This information may be indicative of a fixed or variable customer credit amount to be awarded for participation in the marketing activity. This measure indicative of an amount to be awarded may be reported to the Merchant Server 110 in the Completion Indication message at step 306.

At step 307, the Merchant Server 110 may then update an account of the user of the UE 150 on the Account Server 120 by informing the Account Server 120 in a Balance Update Request message. This message may include information about the account identification in form of the device identification (UE ID) indicative of an earnings amount received earlier and the customer credit amount to be awarded to the account.

At step 308, the Account Server 120 may, in response to receiving the Balance Update Request message, update the customer earnings account accordingly and confirms the update in a Balance Update Confirm message that is transmitted to the Message Server 110. The Account Server 120 may, after updating, verify whether the balance of the customer earning account exceeds a pre-defined threshold and include this verification result in the Balance Update Confirm message.

In the case that the balance of the customer earning account exceeds the pre-defined threshold, the Merchant Server 110 may at step 309 transmit to the UE 150 an Enrollment Request message to invite the customer to enroll with a payment service for redeeming proceeds from the balance of the earning account. The Enrollment Request message may contain information relating to the account balance. The Enrollment Request may also contain information relating to one or more payers associated with the payment service for providing earnings to the user of the UE 150.

The UE may then present to its customer information about the invitation to the enrollment at Block 310, including presentation of the current updated balance of the earnings account and an optional display of election means to elect one of multiple payers indicated in the Enrollment Request. The UE then requests input from the user as to accept the enrollment request and elect a payer and transmits an Enrollment Response message with the information about accepted enrollment and elected one or more payers back to the Merchant Server at step 311.

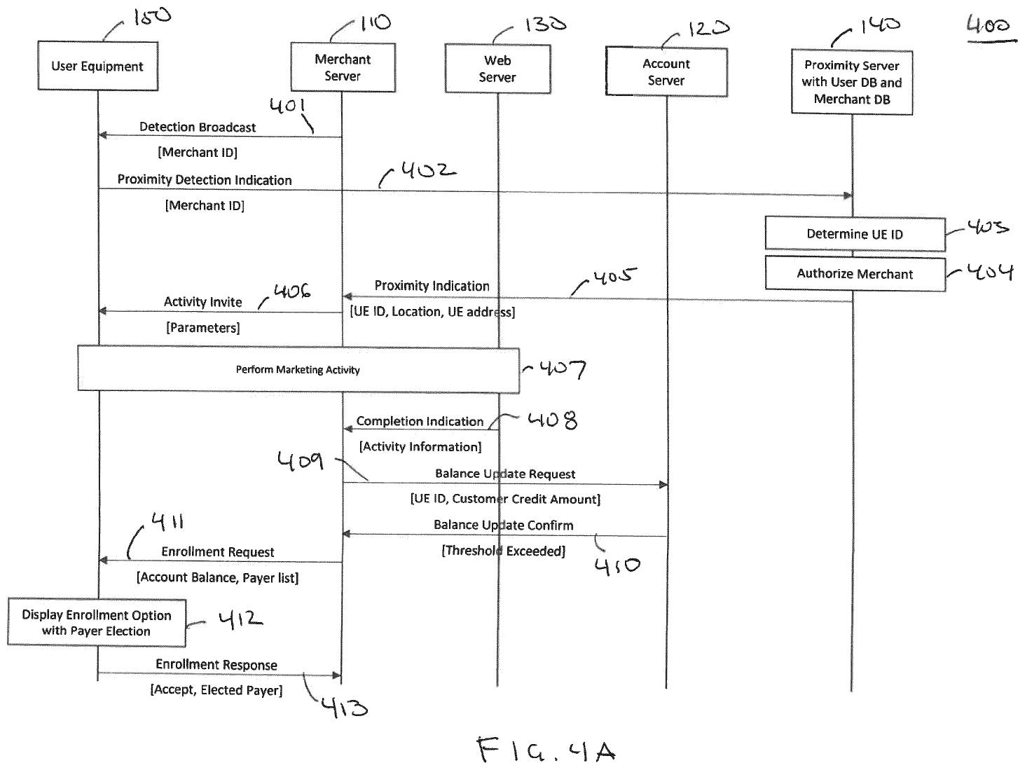

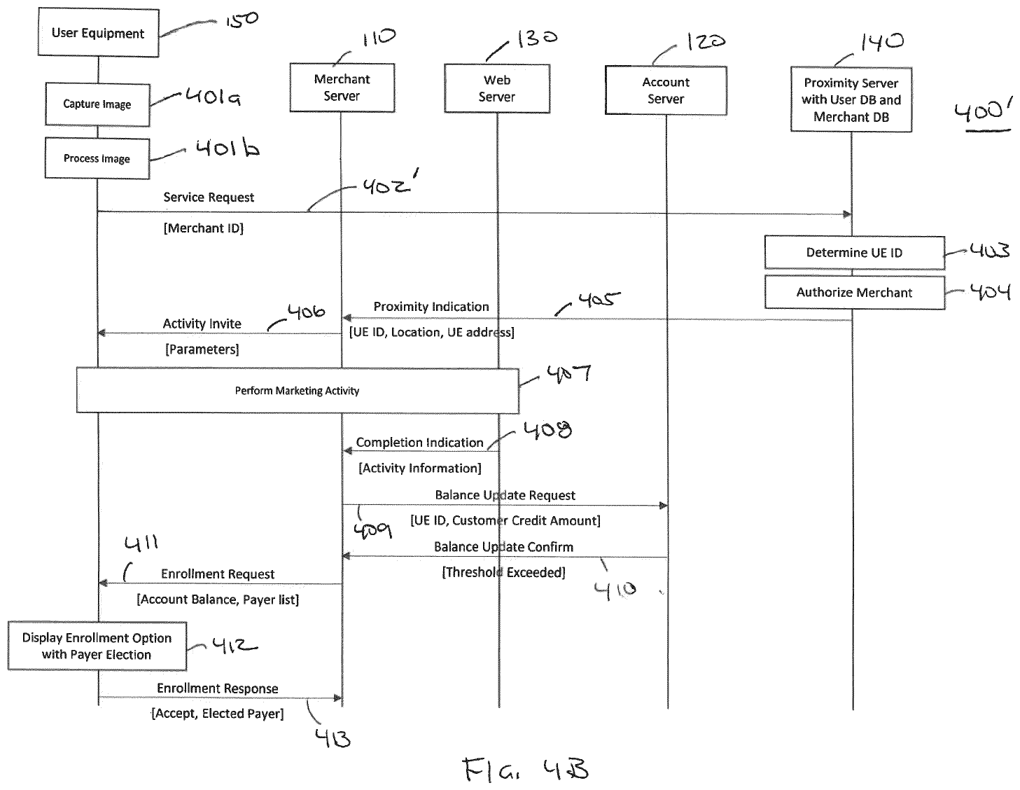

FIG. 4A depicts a Method 400 in accordance with aspects of this disclosure by means of a message sequence chart. The method can be carried out, for example, by the Network Infrastructure 100′ illustrated in FIG. 2.

The Method 400 of FIG. 4A is similar to the Method 300 of FIG. 3, with some variation in the detection of a proximity indication. In accordance with the method illustrated by FIG. 4, the Merchant Server 110 at step 401 broadcasts a Detection Broadcast signal comprising a temporary or permanent Merchant ID. At step 402, the UE 150 detects the broadcast signal and informs a Proximity Server 140 about detection of the broadcast signal and the Merchant ID.

As illustrated by Blocks 403, 404 of FIG. 4A, Proximity Server 140 determines an ID of the UE 150 from the received Proximity Detection Indication, and looks up in the User DB 145 (not shown in FIG. 4A) whether the UE 150 is authorized to use communicate with the Merchant Server 110. The Proximity Server 140 may also look up authorization information of the detected merchant associated with the Merchant Server 110 to authorize the merchant to communicate with the UE 150. If authorization is indicated in both cases, the Proximity Server 140 may indicate to the Merchant Server 110 at step 405 in a Proximity Indication message that the UE 150 is present adjacent to or within the merchant location. The Proximity Indication message may further comprise a UE ID that is indicative of an earnings account of the customer associated with the UE 150, the UE ID being determined by the Proximity Server in the data base look-up in the User DB 145.

The Proximity Indication message at step 405 may further include location information (for example, geographical location information and/or a merchant shop identification such as the Merchant ID received by the UE 150 at step 401). The Merchant ID may thus identify the merchant as used by the Proximity Server for authorization verification, and it may additionally identify a specific location or shop out of multiple operated by the merchant.

The Proximity Indication message of step 405 may further comprise a UE address which allows the Merchant Server 110 to transmit messages to the UE 150. The UE address may be identical to the UE ID indicative of an earnings account (e.g. it may be an MSISDN, a telephone number, a URL, a SIP-address or the like).

At step 405, he Merchant Server 110 receives the Proximity Indication message as an indication for the presence of a UE 150 in or near its location, and in addition for reception of a UE ID indicative of an earnings account. The Merchant Server 110 can then, for example, follow the method described with reference to FIG. 3 and as illustrated at step 406 of FIG. 4 to transmit an Activity Invite message to the UE 150, either via direct communication means or indirectly via a cellular or wireless communication network.

Not shown in FIG. 4A is an option of the Proximity Server, after having determined the UE ID and authorized the UE 150 to communicate with the Merchant Server 110, to send a Proximity Detection Confirm back to the UE 150 indicating an authorization to communicate with or accept message from the merchant and optionally a merchant ID that will be used in such communication. This option advantageously provides an additional means for securing the communication between nodes based on proximity services.

The remaining elements of the Method 400 of FIG. 4 may preferably correspond to previously-described elements of the Method 300 of FIG. 3. More specifically, steps 408-410 and 412 of FIG. 4 respectively correspond to steps 306-309 and 311 of FIG. 3, and blocks 407 and 412 of FIG. 4 respectively correspond to blocks 305 and 310 of FIG. 3.

FIG. 4B depicts a Method 400′ in accordance with aspects of this disclosure by means of a message sequence chart. The method can be carried out, for example, by the Network Infrastructure 100′ illustrated in FIG. 2.

The Method 400′ of FIG. 4B is similar to the Method 400 of FIG. 4A, with the following differences. In the Method 400′, the process does not begin with receipt by the UE 150 of a Detection Broadcast transmitted by the Merchant Server 110 (see step 401 of the Method 400 illustrated in FIG. 4A). In the Method 400′, a user in possession of the UE 150 has either approached or entered a shop of the merchant, and observed signage positioned or placed by the merchant to solicit participants for the paid marketing activity. The UE 150 is configured with a Marketing Activity Participation app that is able to engage a camera element of the UE 150 to capture a graphical image from the signage at step 401a of FIG. 4B (for example, a quick response or “QR” code disposed on the signage), and then process the graphical image at step 401b to extract information that is indicative of a merchant ID, and preferably, a merchant store location. In cases where more than one marketing activity may be occurring in the store, the information may also preferably include an activity identifier or other more specific identifier (for example, “third floor” or “electronics”).

At step 402′ of FIG. 4B, the UE 150 may then preferably proceed to transmit a service request to the Proximity Server 140 that includes the extracted merchant and marketing activity information together with a UE identifier as described above in relation to FIG. 4A. The UE 150 may, for example, transmit this information to the Proximity Server 140 over an internet and/or other network connection according to a network address of the Proximity Server 140 that, for example, is stored by the app on the UE 150 or provided to the UE 150 by decoding the graphical image disposed on the store signage.

As illustrated by Blocks 403, 404 of FIG. 4B, Proximity Server 140 determines an ID of the UE 150 from the received Service Request, and looks up in the User DB 145 (not shown in FIG. 4B) whether the UE 150 is authorized to use communicate with the Merchant Server 110. The Proximity Server 140 may also look up authorization information of the detected merchant associated with the Merchant Server 110 to authorize the merchant to communicate with the UE 150. If authorization is indicated in both cases, the Proximity Server 140 may indicate to the Merchant Server 110 at step 405 in a Proximity Indication message that the UE 150 is present adjacent to or within the merchant location. The Proximity Indication message may further indicate an earnings account of the customer associated with the UE 150.

Alternatively to steps 402′ and 403-405, the UE 150 may transmit the service request directly to one of the Merchant Server 110 or the Web Server 130. In this case, the Merchant Server 110 or Web Server 130 would determine the ID of the UE 150 and associated earnings account of the customer from the information transmitted in the service request and/or via additional queries directed to the UE 150.

The remaining elements of the Method 400′ of FIG. 4B may preferably correspond to previously-described, identically reference-numbered elements of the Method 400 of FIG. 4A.

The Methods 300, 400 respectively illustrated in FIGS. 3, 4A can be identified as “push” methods, in which the merchant invites users to participate in marketing activities simply by determining a physical presence of the users in proximity to a merchant store. By contrast, the Method 400′ of FIG. 4B represents a “pull” method, which requires a positive interest and actions by a user (image capture and analysis of marketing activity opportunity, and issuance of a specific service request) before the merchant invites user participation. This latter approach advantageously provides the user with autonomy in deciding to participate in the invited marketing activities as described herein.

It will be understood that, while various aspects of the present disclosure have been illustrated and described by way of example, the invention claimed herein is not limited thereto, but may be otherwise variously embodied within the scope of the following claims. For example, it should be understood that while the completion indication 306, 408 of FIGS. 3, 4A and 4B is shown as being provided to the Merchant Server 110 by the Web Server 130 as a prelude to the Merchant Server 110 issuing a Balance Update Request 307, 409 to the Account Server 120, the completion indication 306, 408 could alternatively be self-reported by the UE 150. For example, the UE 150 could self-report the completion indication 306, 408 upon user completion and submission of a form administered by the UE 150. Alternatively, the completion indication 306, 408 could be generated directly by the Merchant Server 110 upon the departure of the UE 150 from a geo-fence of the Merchant Server 110.

The following table lists the reference characters and names of features and elements used herein: Reference characters assigned to method steps are not listed.

| Ref. char. | Feature or element |
|---|---|
| 100 | Network Infrastructure |
| 100′ | Network Infrastructure |
| 110 | Merchant Server |
| 120 | Account Server |
| 130 | Web Server |
| 140 | Proximity Server |
| 145 | User Database |
| 150 | User Equipment |
| 160 | Network |

1. A computer-implemented method for generating an earnings credit to a customer having a mobile electronic device for participation in a marketing activity at a merchant location, the method comprising the steps of:
a. receiving device identification information at a merchant server indicative of a presence of the customer at or near the merchant location;
b. transmitting information to the mobile electronic device by the merchant server inviting participation by the customer in a marketing activity at the merchant location;
c. receiving an indication at the merchant server of a completion of the marketing activity by the customer;
d. issuing a request by the merchant server that a balance in an earnings account of the customer be updated to include a customer credit amount provided by the merchant for completion of the marketing activity; and
e. determining whether the updated balance in the earnings account exceeds a predetermined threshold amount.

2. The computer-implemented method of claim 1, further comprising the step of transmitting a message by the merchant server to the mobile electronic device when the updated balance in the earnings account exceeds the predetermined threshold amount.

3. The computer-implemented method of claim 2, wherein the message requests the customer to enroll with a payment service for redeeming proceeds from the balance in the earnings account.

4. The computer-implemented method of claim 2, wherein the message informs the customer as to the balance in the earnings account.

5. The computer-implemented method of claim 3, wherein the message identifies at least one payer for election as the payment service.

6. The computer-implemented method of claim 1, wherein the step of receiving device identification information at the merchant server includes the step of receiving a service request from the mobile electronic device of the customer at the merchant server, the service request made by the mobile electronic device enabled by a service code imaged by the mobile electronic device from signage displayed at the merchant location.

7. The computer-implemented method of claim 1, wherein the step of receiving device identification information at the merchant server includes the step of receiving a detection broadcast signal from the mobile electronic device at the merchant server.

8. The computer-implemented method of claim 1, wherein the step of receiving device identification information at the merchant server includes the step of receiving a proximity detection indication signal at the merchant server from a proximity server in communication with the merchant server and the mobile electronic device.

9. The computer-implemented method of claim 1, wherein the step of transmitting information to the mobile electronic device inviting participation by the customer in a merchant location-based marketing activity further includes the steps of:
a. querying one of the mobile electronic device, an account server in communication with the merchant server or a network-accessible data store by the merchant server to obtain information indicating current interests of the customer; and
b. transmitting the activity information to the mobile electronic device by the merchant server upon determining that the current interests of the customer and the merchant location-based marketing activity are correlated.

10. The computer-implemented method of claim 1, wherein one or more of the mobile electronic device, the merchant server or a network-accessible web server is configured as a marketing activity hosting node for one or more of monitoring user participation in the marketing activity or soliciting a user response to the marketing activity.

11. The computer-implemented method of claim 10, wherein the marketing activity hosting node is configured to generate a completion indicator for the marketing activity.

12. The computer-implemented method of claim 11, wherein the completion indicator is generated by the marketing activity hosting node by determining that the mobile electronic device was in proximity to the merchant location for at least a predetermined time period.

13. The computer-implemented method of claim 12, wherein the time period for which the mobile device is in proximity to the merchant location is determined as a function of a time of entry of the mobile electronic device into a geo-fence of the merchant location and a time of departure of the mobile electronic device from the geo-fence of the merchant location

14. The computer-implemented method of claim 11, wherein the completion indicator is generated by the marketing activity hosting node upon receiving a user activity completion response from one of the mobile electronic device or a another terminal device at the merchant location.

15. The computer-implemented method of claim 14, wherein the activity completion response is a survey response.

16. The computer-implemented method of claim 15, wherein the survey response includes an authentication indicator provided by the user.
